(19) United States
(12) Patent Application Publication
(10) Pub. No.: US 2026/0003813 A1
(43) Pub. Date: Jan. 1, 2026

(54) COMMUNICATION METHOD FOR SINGLE-BUS SYSTEM

(71) Applicant: HUIZHOU HAPPY VAPING TECHNOLOGY LIMITED, Huizhou (CN)

(72) Inventor: Xiyong Zhang, Shenzhen (CN)

(21) Appl. No.: 19/318,441

(22) Filed: Sep. 4, 2025

Related U.S. Application Data
(63) Continuation-in-part of application No. PCT/CN2024/071417, filed on Jan. 9, 2024.

(30) Foreign Application Priority Data
Mar. 7, 2023 (CN) 202310247726.4

(51) Int. Cl. G06F 13/36

(52) U.S. Cl. CPC G06F 13/36; G06F 2213/0002

(57) ABSTRACT

A communication method for a single-bus system includes following steps: Si: sending, by the master device, a reset signal with a specific timeslot corresponding to a task through the single bus to select a corresponding slave device and query a status of the corresponding slave device; S2: after receiving the reset signal, sending, by the slave device, an acknowledgment signal with a specific timeslot through the single bus; S3: after receiving the acknowledgment signal, sending, by the master device, a serial signal of an instruction, an address, and/or data through the single bus; and S4: receiving, by the slave device, the serial signal through the single bus, decoding the serial signal through the microprocessor module, and generating a corresponding control signal to control a module contained in the slave device to complete a task corresponding to the control signal.

### CROSS REFERENCE TO RELATED APPLICATIONS

The present application is a Continuation-In-Part Application of PCT Application No. PCT/CN2024/071417 filed on January 9, 2024, which claims the benefit of Chinese Patent Application No. 202310247726.4 filed on March 7, 2023. All the above are hereby incorporated by reference in their entirety.

### TECHNICAL FIELD

The present disclosure relates to the technical field of integrated circuit (IC) design, and more specifically, to a communication method for a single-bus system.

### BACKGROUND

The 1-Wire bus is a peripheral serial expansion bus technology developed by DALLAS Semiconductor in the United States. Unlike Serial Peripheral Interface (SPI) and Inter-Integrated Circuit (PC) serial data communication methods, the 1-Wire bus adopts a single signal line for clock transmission and bidirectional data transmission, which has advantages including reduced I/O port lines, a simplified resource structure, a low cost, and ease of bus expansion and maintenance. In such a 1-Wire bus protocol, a system is constituted by one master bus node or a plurality of slave nodes, and data is read from a slave chip through the single signal line. Each slave chip in compliance with the 1-Wire bus protocol has a unique address including a 48-bit serial number, an 8-bit family code, and an 8-bit Cyclic Redundancy Check (CRC) code. A master chip communicates bidirectionally with each chip based on 64-bit addressing. Therefore, the 1-Wire bus protocol has a strict requirement for a timing sequence in initialization, bit writing, or bit reading.

In the prior art, when a plurality of slave devices connect to the 1-Wire bus, a master device primarily identifies a communication object based on unique identity information of a slave device. That is, identity authentication is required before actual communication, which limits a speed of single-bus communication. In addition, the identity information of the slave device is mainly transmitted as a digital signal, and may be reversely cracked in a slave device that requires encryption protection, reducing information security.

### SUMMARY

### Technical Problems

An objective of the present disclosure is to provide a communication method for a single-bus system to overcome shortcomings in the prior art.

### Technical Solutions

The technical solutions in the present disclosure are implemented as follows: A communication method for a single-bus system is applied to the single-bus system, where the single-bus system includes a master device and a plurality of slave devices, the master device is communicatively connected to the plurality of slave devices through a single bus, and each of the plurality of slave devices includes an interface module, a power management module, a microprocessor module, a clock module, and a storage module; and the communication method for a single-bus system includes following steps:

S1: sending, by the master device, a reset signal with a specific timeslot corresponding to a task through the single bus to select a slave device corresponding to the specific timeslot corresponding to the task and query a status of the slave device corresponding to the specific timeslot corresponding to the task, where the plurality of slave devices correspond one-to-one with a plurality of non-repeating specific timeslots, and the slave device responds to only a signal with a specific timeslot corresponding to the slave device;

S2: after receiving the reset signal, sending, by the slave device corresponding to the specific timeslot, an acknowledgment signal with the specific timeslot through the single bus, and entering a state of waiting to receive a signal sent by the master device through the single bus;

S3: after receiving the acknowledgment signal, sending, by the master device, a serial signal of an instruction, an address, and/or data through the single bus; and

S4: receiving, by the slave device corresponding to the specific timeslot, the serial signal through the single bus, decoding the serial signal through the microprocessor module, and generating a control signal corresponding to the decoded serial signal to control a module contained in the slave device to complete a task corresponding to the control signal.

Preferably, each of the plurality of slave devices is electrically connected to the master device through the interface module and the single bus, and the interface module is configured to exchange input data and output data; and

in each of the plurality of slave devices,

the microprocessor module is electrically connected to the interface module, the power management module, the clock module, and the storage module, and is configured to receive instruction information and data information, and convert the instruction information and the data information into a corresponding control signal to control the module contained in the slave device to complete a task corresponding to the control signal;

the power management module is electrically connected to the interface module, the microprocessor module, the clock module, and the storage module, and is configured to supply power to the connected modules;

the clock module is configured to provide a clock signal; and

the storage module is configured to store and read data.

Preferably, the power management module is internally provided with a parasitic power supply circuit; and when the single bus is at a high level, the power management module supplies power to connected modules while charging the parasitic power supply circuit; or when the single bus is at a low level, the parasitic power supply circuit supplies power to modules connected to the power management module.

Preferably, a clock frequency of the clock module is set based on configuration information.

Preferably, different timeslots of the reset signal and the acknowledgment signal correspond one-to-one with the plurality of slave devices, and the slave device responds to only a reset signal with a corresponding timeslot.

Preferably, for a timeslot of the signal sent by the master device on the single bus, a write-0 timeslot of the timeslot of the signal sent by the master device is greater than a maximum value of a sampled signal of the slave device, and a write-1 timeslot of the timeslot of the signal sent by the master device is less than a minimum value of the sampled signal of the slave device.

Preferably, for a timeslot of the signal sent by the slave device on the single bus, a write-0 timeslot of the timeslot of the signal sent by the slave device is greater than a maximum value of a sampled signal of the master device, and a write-1 timeslot of the timeslot of the signal sent by the slave device is less than a minimum value of the sampled signal of the master device.

### Beneficial Effects

The present disclosure utilizes reset and acknowledgment signals of different timeslots to enable a master device in a single-bus system to select and query any slave device. Compared with selection and query methods for identity information verification in an existing single-bus system communication technology, the present disclosure not only reduces communication time and complexity, but also further improves information security through a physical encryption method in which reset timeslots correspond one-to-one with acknowledgment timeslots.

### BRIEF DESCRIPTION OF THE DRAWINGS

FIG. 1 is a schematic connection diagram of a single-bus system according to an embodiment of the present disclosure;

FIG. 2 is a schematic diagram of internal connection of a slave device in a single-bus system according to an embodiment of the present disclosure;

FIG. 3 shows steps of a communication method for a single-bus system according to an embodiment of the present disclosure;

FIG. 4 shows a timing sequence of a communication method for a single-bus system according to an embodiment of the present disclosure;

FIG. 5 shows a timeslot of a communication reset/acknowledgment signal in a single-bus system according to an embodiment of the present disclosure;

FIG. 6 shows a timeslot of a communication reset/acknowledgment signal of a master device in a single-bus system according to an embodiment of the present disclosure; and

FIG. 7 shows a timeslot of a communication reset/acknowledgment signal of a slave device in a single-bus system according to an embodiment of the present disclosure.

### DETAILED DESCRIPTION

### Optimal Implementations of the Present Disclosure

A communication method for a single-bus system in the present disclosure utilizes reset and acknowledgment signals of different timeslots to enable a master device in the single-bus system to select and query any slave device. Compared with selection and query methods for identity information verification in an existing single-bus system communication technology, the present disclosure not only reduces communication time and complexity, but also further improves information security through a physical encryption method in which reset timeslots correspond one-to-one with acknowledgment timeslots.

### Implementations of the Present Disclosure

The present disclosure will be described in detail below in conjunction with specific embodiments.

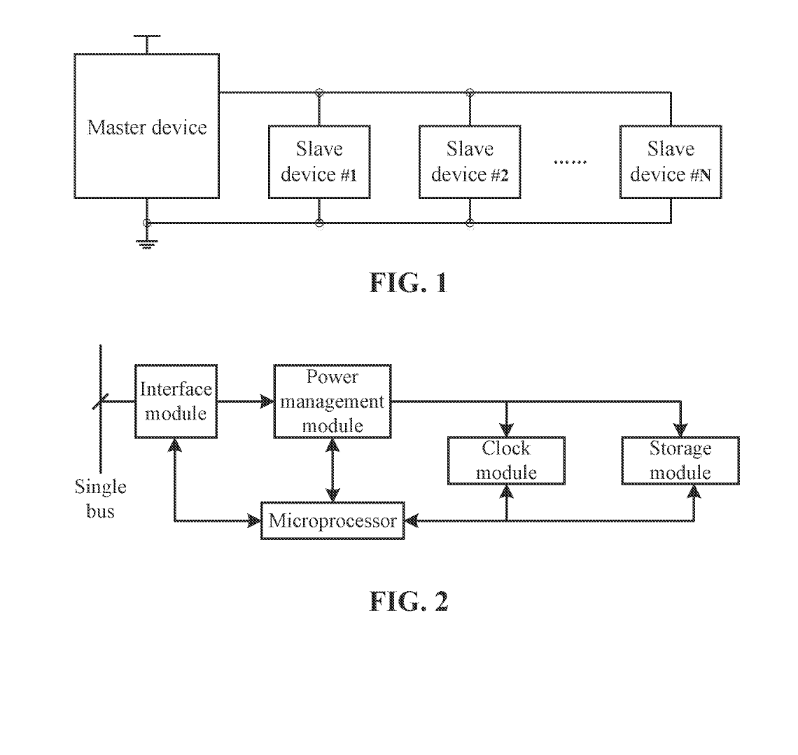

As shown in FIG. 1 and FIG. 2, a communication method for a single-bus system in the present disclosure is applied to the single-bus system. The single-bus system includes a master device and N slave devices, the master device connects to and communicates with the N slave devices simultaneously through a single bus, and each slave device includes an interface module, a power management module, a microprocessor module, a clock module, and a storage module that are electrically connected.

Each slave device is electrically connected to the master device through the interface module and the single bus, and the interface module is configured to exchange input data and output data.

In each slave device,

the microprocessor module is electrically connected to other modules (the interface module, the power management module, the clock module, and the storage module) in the slave device, and is configured to receive instruction information and data information, and convert the received instruction information and data information into a corresponding control signal to control a module contained in the slave device to complete a task corresponding to the control signal;

the power management module is electrically connected to other modules (the interface module, the microprocessor module, the clock module, and the storage module) in the slave device, and is configured to supply power to the connected modules;

the clock module is electrically connected to the microprocessor module to provide a clock signal; and

the storage module is electrically connected to the microprocessor module to store and read data.

The power management module is internally provided with a parasitic power supply circuit. When the single bus is at a high level, the power management module supplies power to the connected modules while charging the parasitic power supply circuit; or when the single bus is at a low level, the parasitic power supply circuit supplies power to the modules connected to the power management module. This can ensure that the power management module can supply power to the other modules in the slave device regardless of the high or low level of the single bus, ensuring normal working of the single-bus system.

A clock frequency of the clock module is set based on configuration information. Specifically, when a user modifies a clock frequency value in the configuration information, the clock frequency of the clock module changes accordingly.

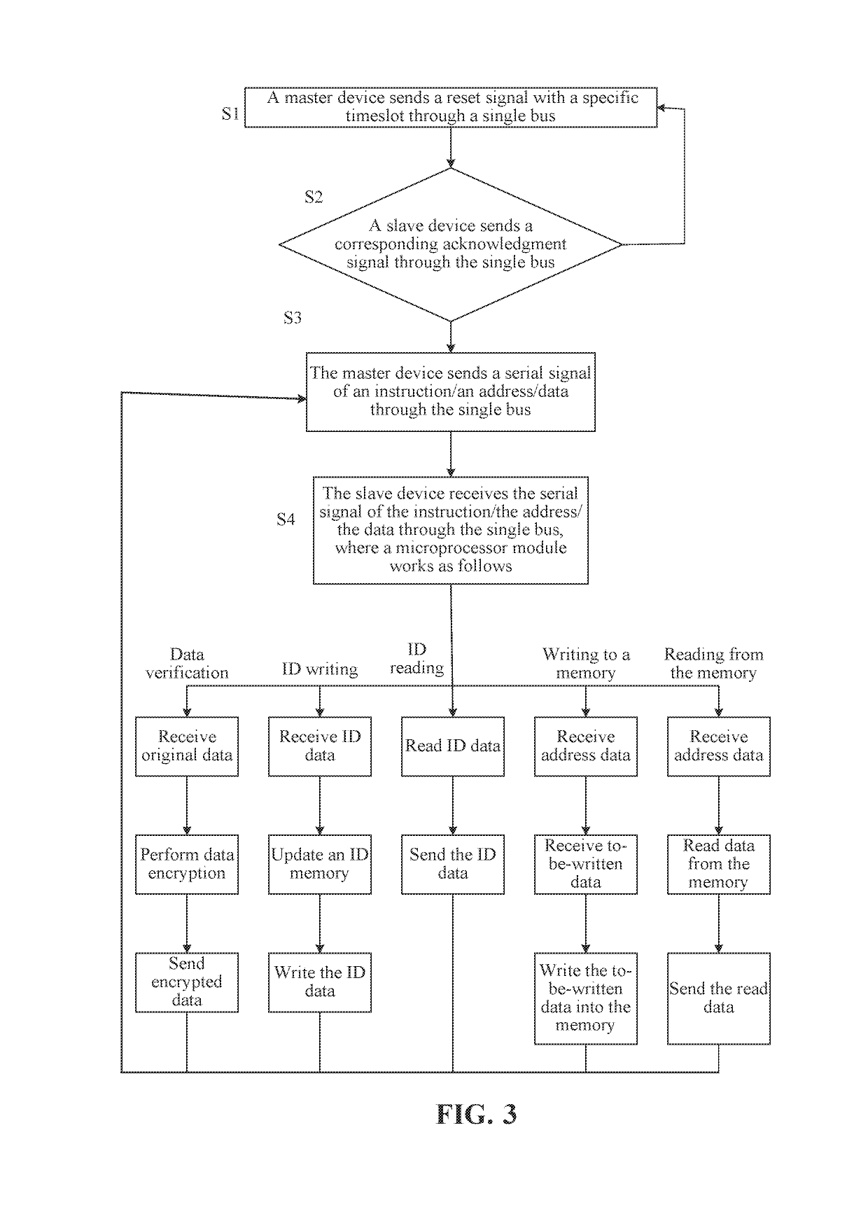

As shown in FIG. 3, a communication method for a single-bus system in the present disclosure includes following steps:

S1: A master device sends a reset signal with a specific timeslot corresponding to a task through a single bus to select a slave device corresponding to the specific timeslot corresponding to the task and query a status of the slave device corresponding to the specific timeslot corresponding to the task, where a plurality of slave devices correspond one-to-one with a plurality of non-repeating specific timeslots, and the slave device responds to only a signal with a specific timeslot corresponding to the slave device.

Specifically, the task includes specified slave device information, and the specific timeslot corresponding to the task is a specific timeslot corresponding to a specified slave device.

S2: After receiving the reset signal, the slave device corresponding to the specific timeslot sends an acknowledgment signal with the specific timeslot through the single bus, and enters a state of waiting to receive a signal sent by the master device through the single bus.

S3: After receiving the acknowledgment signal, the master device sends a serial signal of an instruction, an address, and/or data through the single bus.

Specifically, the single bus sends the serial signal of the instruction, the address, and/or the data.

S4: The slave device corresponding to the specific timeslot receives the serial signal through the single bus, decodes the serial signal through a microprocessor module, and generates a control signal corresponding to the decoded serial signal to control a module contained in the slave device to complete a task corresponding to the control signal.

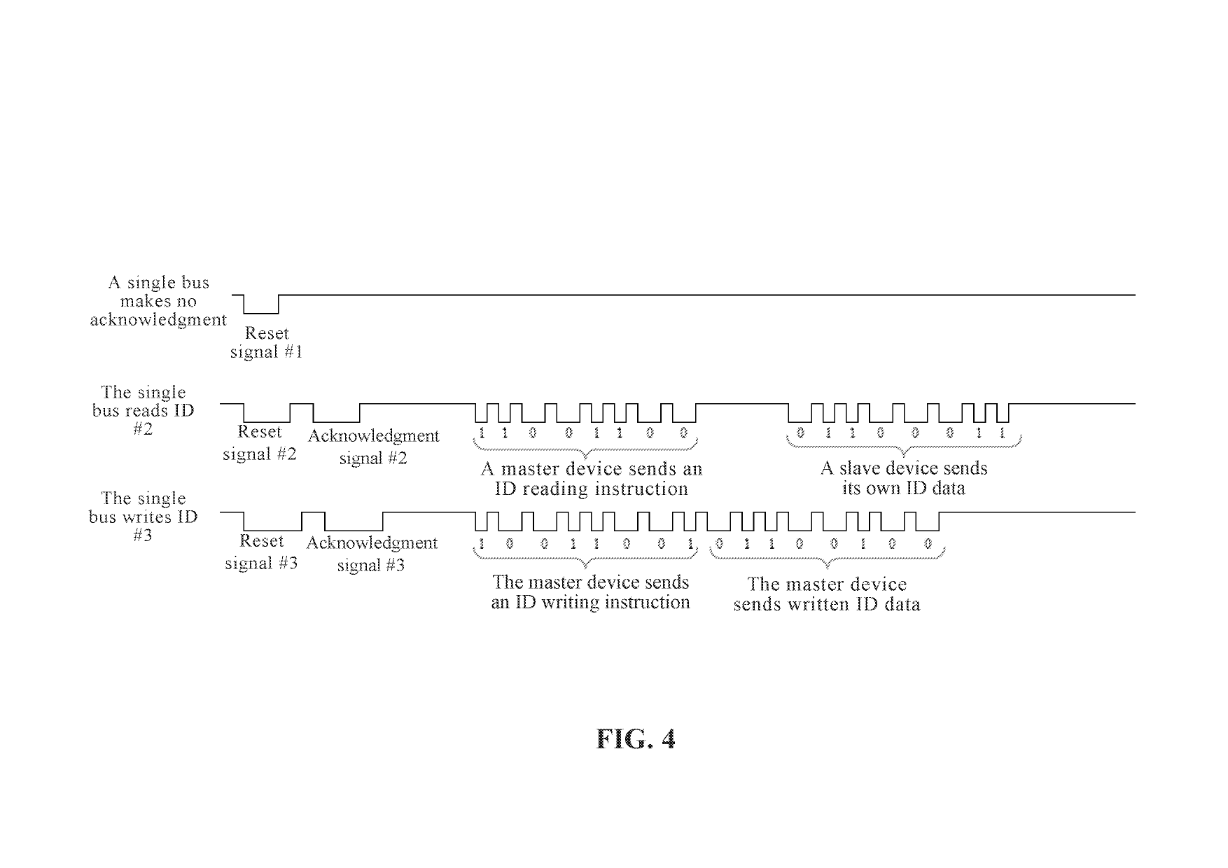

As shown in FIG. 4, in an embodiment, a timing sequence of the communication method for a single-bus system is as follows:

1. The master device sends a reset signal #1 of a specific timeslot through the single bus, and there is no acknowledgment signal from the single bus, that is, a slave device selected/queried by the master device does not exist or is busy.

2. The master device sends a reset signal #2 of a specific timeslot through the single bus.

After receiving the reset signal #2 of the specific timeslot, a slave device sends an acknowledgment signal #2 of the specific timeslot through the single bus.

After receiving the acknowledgment signal #2, the master device sends a serial signal "11001100" of an identifier (ID) reading instruction through the single bus.

The slave device receives the serial signal of the ID reading instruction through the single bus. The microprocessor module decodes the serial signal of the ID reading instruction, and generates a corresponding control signal to control the slave device to send its ID data "01100011" through the single bus. Specifically, the microprocessor module may be a microprocessor.

3. The master device sends a reset signal #3 of a specific timeslot through the single bus.

After receiving the reset signal #3 of the specific timeslot, a slave device sends an acknowledgment signal #3 of the specific timeslot through the single bus.

After receiving the acknowledgment signal #3, the master device sends a serial signal "10011001" of an ID writing instruction and a serial signal "01100100" of written data through the single bus.

The slave device receives the serial signal of the ID writing instruction and the serial signal of the written data through the single bus. The microprocessor decodes the serial signal of the ID writing instruction and generates a corresponding internal signal to control the slave device to update its ID register data to "01100100", and also writes the ID data "01100100".

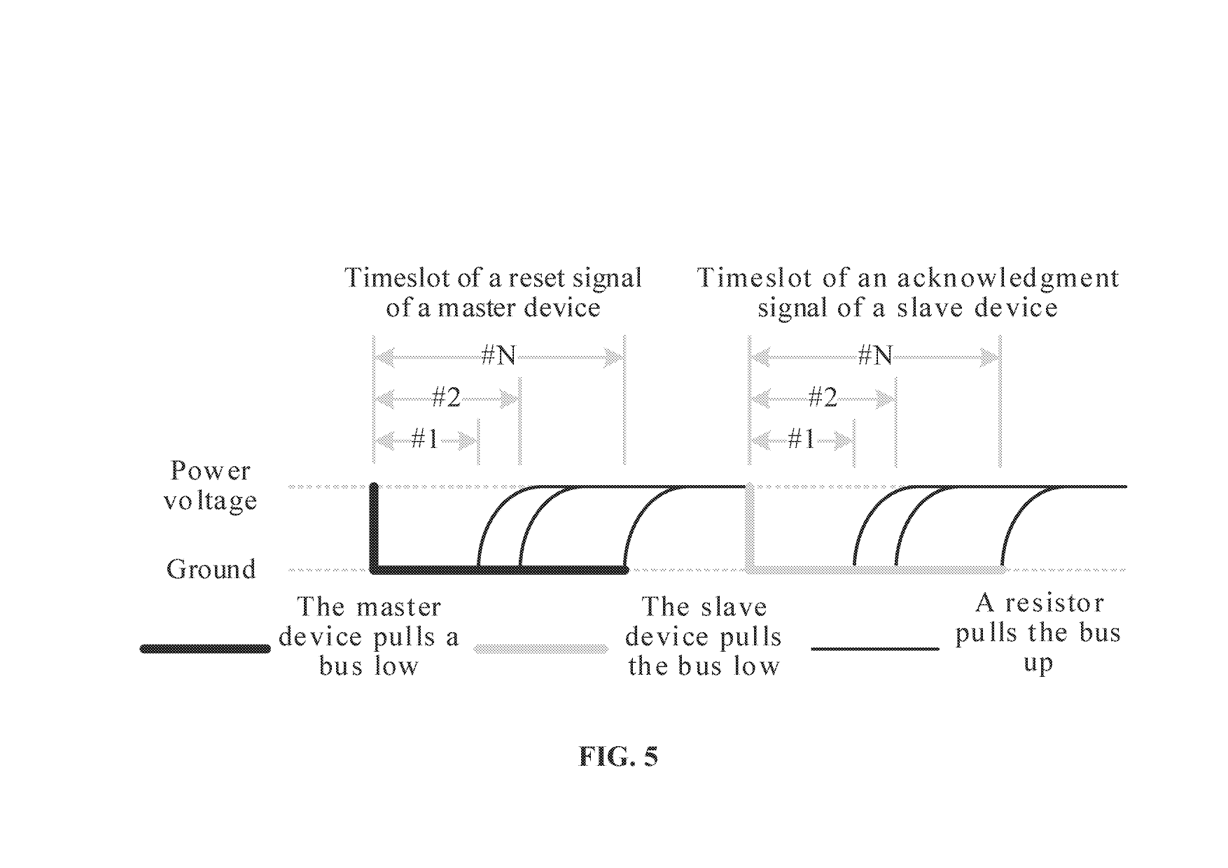

As shown in FIG. 5 , different timeslots of the reset signal and the acknowledgment signal of the single bus in the present disclosure correspond one-to-one with the slave devices, and the slave device responds to only a reset signal with a corresponding timeslot.

Specifically, as shown in the figure, a plurality of specific timeslots #1 to #N with different timeslot lengths can be set in an ascending order, where N is the same as a quantity of slave devices included in the single-bus system. Therefore, in the single-bus system, the slave devices correspond one-to-one with the non-repeating specific timeslots.

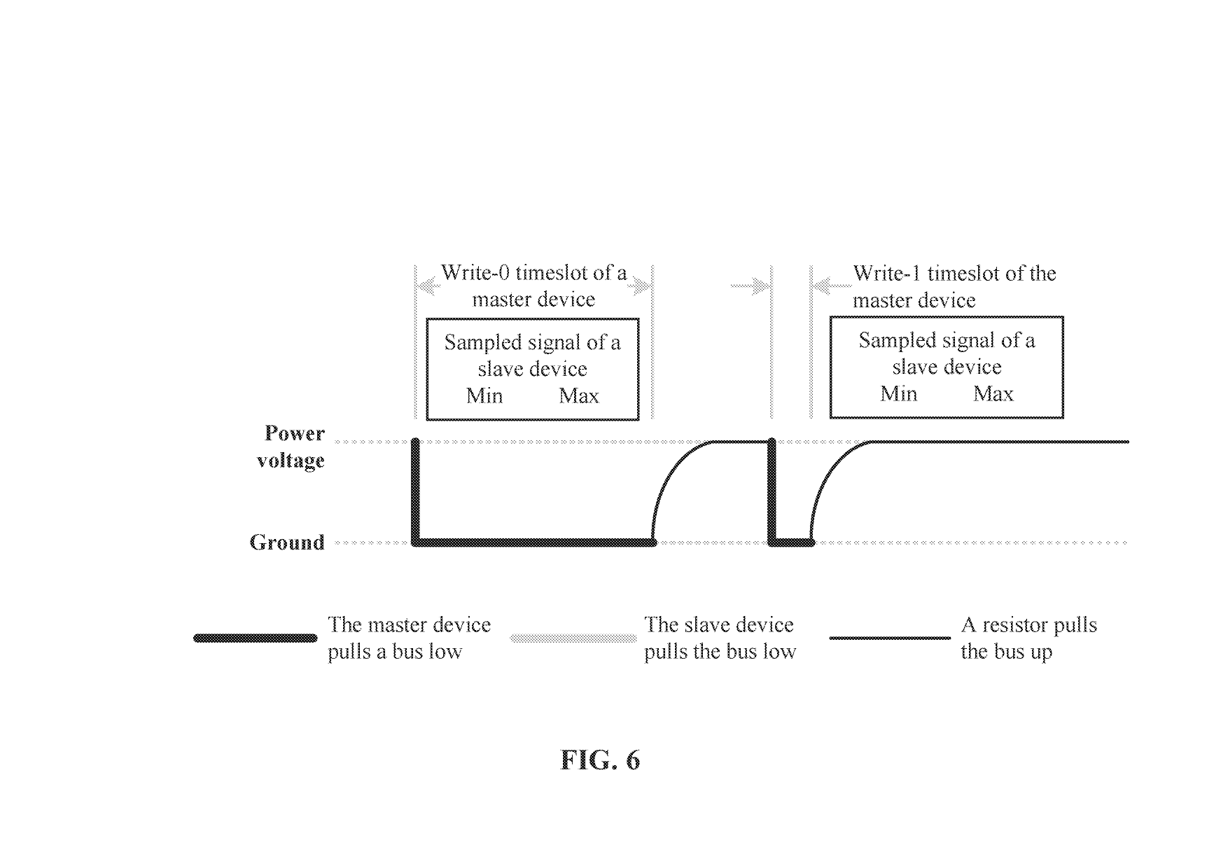

As shown in FIG. 6, for a timeslot of the signal sent by the master device on the single bus in the present disclosure, a write-0 timeslot of the timeslot of the signal sent by the master device is greater than a maximum value of a sampled signal of the slave device, and a write-1 timeslot of the timeslot of the signal sent by the master device is less than a minimum value of the sampled signal of the slave device.

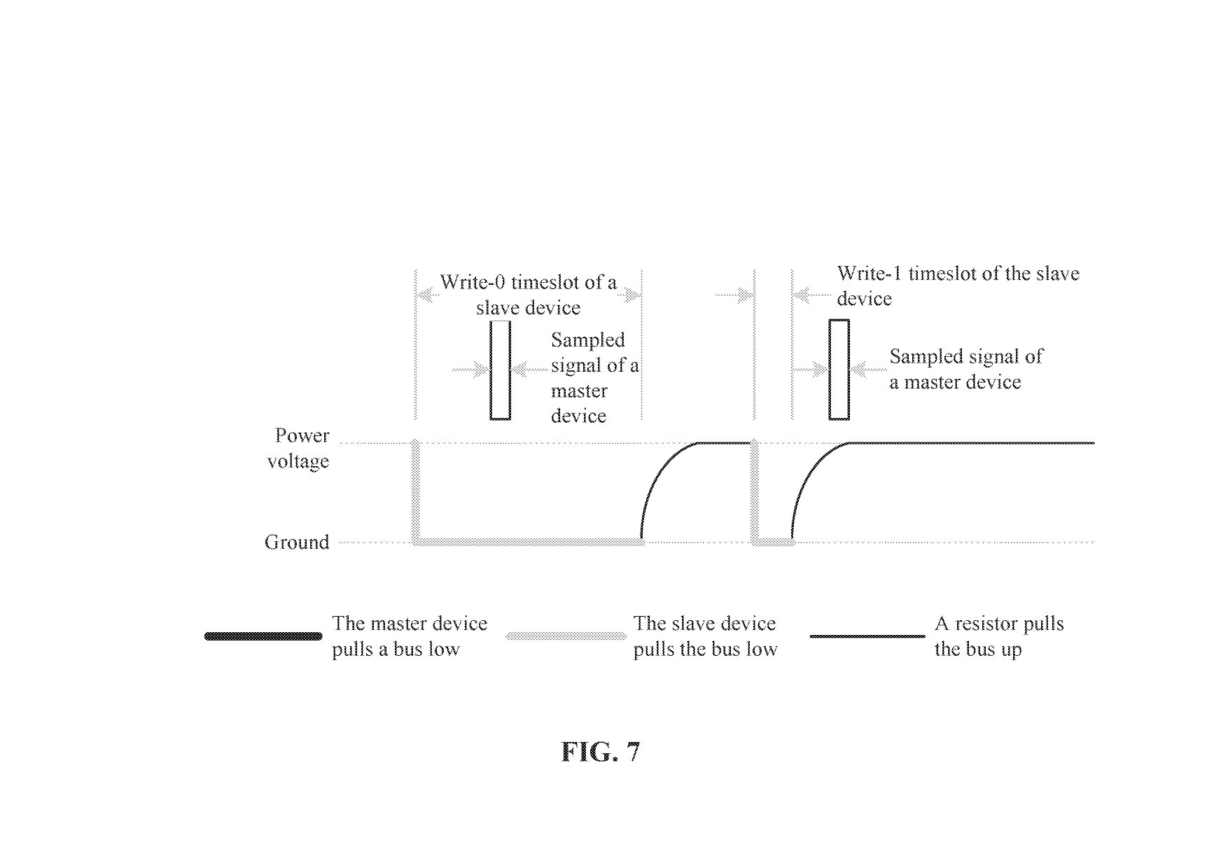

As shown in FIG. 7, for a timeslot of a signal sent by the slave device on the single bus in the present disclosure, a write-0 timeslot of the timeslot of the signal sent by the slave device is greater than a maximum value of a sampled signal of the master device, and a write-1 timeslot of the timeslot of the signal sent by the slave device is less than a minimum value of the sampled signal of the master device.

In the embodiments of the present disclosure, the interface module, the power management module, the microprocessor module, the clock module, and the storage module in the slave device each may be one or more processors, controllers or chips that each have a communication interface, can realize a communication protocol, and may further include a memory, a related interface and system transmission bus, and the like if necessary. The processor, the controller, or the chip executes program-related code to realize a corresponding function.

### Industrial Applicability

The above are merely preferred embodiments of the present disclosure, and all equivalent changes and modifications made according to the scope of the claims of the present disclosure shall fall within the scope covered by the claims of the present disclosure.

1. A communication method for a single-bus system, applied to the single-bus system, wherein the single-bus system comprises a master device and a plurality of slave devices, the master device is communicatively connected to the plurality of slave devices through a single bus, and each of the plurality of slave devices comprises an interface module, a power management module, a microprocessor module, a clock module, and a storage module; and the communication method for a single-bus system comprises following steps:
S1: sending, by the master device, a reset signal with a specific timeslot corresponding to a task through the single bus to select a slave device corresponding to the specific timeslot corresponding to the task and query a status of the slave device corresponding to the specific timeslot corresponding to the task, wherein the plurality of slave devices correspond one-to-one with a plurality of non-repeating specific timeslots, and the slave device responds to only a signal with a specific timeslot corresponding to the slave device;
S2: after receiving the reset signal, sending, by the slave device corresponding to the specific timeslot, an acknowledgment signal with the specific timeslot through the single bus, and entering a state of waiting to receive a signal sent by the master device through the single bus;
S3: after receiving the acknowledgment signal, sending, by the master device, a serial signal of an instruction, an address, and/or data through the single bus; and
S4: receiving, by the slave device corresponding to the specific timeslot, the serial signal through the single bus, decoding the serial signal through the microprocessor module, and generating a control signal corresponding to the decoded serial signal to control a module contained in the slave device to complete a task corresponding to the control signal.

2. The communication method for a single-bus system according to claim 1, wherein each of the plurality of slave devices is electrically connected to the master device through the interface module and the single bus, and the interface module is configured to exchange input data and output data; and
in each of the plurality of slave devices,
the microprocessor module is electrically connected to the interface module, the power management module, the clock module, and the storage module, and is configured to receive instruction information and data information, and convert the instruction information and the data information into a corresponding control signal to control the module contained in the slave device to complete a task corresponding to the control signal;
the power management module is electrically connected to the interface module, the microprocessor module, the clock module, and the storage module, and is configured to supply power to the connected modules;
the clock module is configured to provide a clock signal; and
the storage module is configured to store and read data.

3. The communication method for a single-bus system according to claim 1, wherein the power management module is internally provided with a parasitic power supply circuit; and when the single bus is at a high level, the power management module supplies power to connected modules while charging the parasitic power supply circuit; or when the single bus is at a low level, the parasitic power supply circuit supplies power to modules connected to the power management module.

4. The communication method for a single-bus system according to claim 1, wherein a clock frequency of the clock module is set based on configuration information.

5. The communication method for a single-bus system according to claim 1, wherein different timeslots of the reset signal and the acknowledgment signal correspond one-to-one with the plurality of slave devices, and the slave device responds to only a reset signal with a corresponding timeslot.

6. The communication method for a single-bus system according to claim 1, wherein for a timeslot of the signal sent by the master device on the single bus, a write-0 timeslot of the timeslot of the signal sent by the master device is greater than a maximum value of a sampled signal of the slave device, and a write-1 timeslot of the timeslot of the signal sent by the master device is less than a minimum value of the sampled signal of the slave device.

7. The communication method for a single-bus system according to claim 1, wherein for a timeslot of a signal sent by the slave device on the single bus, a write-0 timeslot of the timeslot of the signal sent by the slave device is greater than a maximum value of a sampled signal of the master device, and a write-1 timeslot of the timeslot of the signal sent by the slave device is less than a minimum value of the sampled signal of the master device.
